(19) United States
(12) Patent Application Publication
(10) Pub. No.: US 2007/0068613 A1
(43) Pub. Date: Mar. 29, 2007

(54) Band for use on a tire

(75) Inventors: Francis J. Byrne, Medina, OH (US); Keith A. Dumigan, Akron, OH (US); Roger Marble, Ravenna, OH (US)

Correspondence Address: Chief IP Counsel;Bridgestone Americas Holding, Inc., 1200 Firestone Parkway, Akron, OH, 44317, US

(73) Assignee: Bridgestone Firestone North American Tire, LLC

(21) Appl. No.: 11/236,896

(22) Filed: Sep. 28, 2005

(51) Int. Cl. B60C 11/00; B32B 3/02

(52) U.S. Cl. 152/208; 152/209.1; 428/66.6

(57) ABSTRACT

A band for use on a tire having a circumferential tread with one or more circumferential grooves provided therein. The band is configured to be installed into one of the grooves in the tread to affect the appearance and/or performance of the tire.

### FIELD OF THE INVENTION

The present application relates to a tire that includes one or more stepped recesses in a tread of the tire. More particularly, the present application relates to a tire that includes one or more stepped recesses in a shoulder region of the tire.

### BACKGROUND

Tires may include features that affect the appearance or performance of the tire. For example, tires may be provided with a tread having a color other than black to enhance the appearance of the tire. Additionally, a reflective material may be molded into the tread of the tire to improve visibility of the tire at night.

To affect performance of the tire, numerous rubber compositions have been proposed to improve snow, wet, and dry traction and handling of the tire. Also, tires are provided with various features such as lugs, slots, and sipes, which can impact the snow, wet, and dry traction and handling of the tire.

### BRIEF DESCRIPTION OF THE DRAWINGS

In the accompanying drawings, embodiments of a tire and method are illustrated that together with the detailed description given below, describe example embodiments of the mechanism and method. It will be appreciated that the illustrated boundaries of elements in the figures represent one example of the boundaries. One of ordinary skill in the art will appreciate that one element may be designed as multiple elements or that multiple elements may be designed as a single element. An element shown as an internal component of another element may be implemented as an external component and vice-versa.

Further, in the accompanying drawings and description that follow, like parts are indicated throughout the drawings and description with the same reference numerals, respectively. The figures are not drawn to scale and the proportions of certain parts have been exaggerated for convenience of illustration.

FIG. 1A illustrates a perspective view of one embodiment of a tire 100 having a band 110 provided thereon to affect the appearance and/or performance of the tire 100.

FIG. 1B illustrates an enlarged, partial cross-sectional view of the tire 100.

FIG. 1C illustrates the tire 100 where the band 110 has a variable cross-section along its length.

FIG. 2 illustrates a perspective view of a portion of one embodiment of a band 210 for use on a tire to affect the appearance and/or performance of the tire.

FIG. 3 illustrates a perspective view of a portion of another embodiment of a band 310 for use on a tire to affect the appearance and/or performance of the tire.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially,” as used herein, refer to a direction that is parallel to the axis of rotation of a tire.

“Circumferential” and “circumferentially,” as used herein, refer to a direction extending along the perimeter of the surface of the annular tread perpendicular to the axial direction.

“Groove,” as used herein, refers to an elongated void area in the tread that may extend circumferentially or laterally in a straight, curved or zig-zag manner.

“Lateral,” as used herein, refers to a direction along the tread of the tire going from one sidewall of a tire to the other sidewall.

“Radial” and “radially,” as used herein, refer to a direction perpendicular to the axis of rotation of a tire.

“Sidewall,” as used herein, refers to that portion of the tire between the tread and the bead.

“Tread,” as used herein, refers to that portion of the tire that comes into contact with the road under normal load.

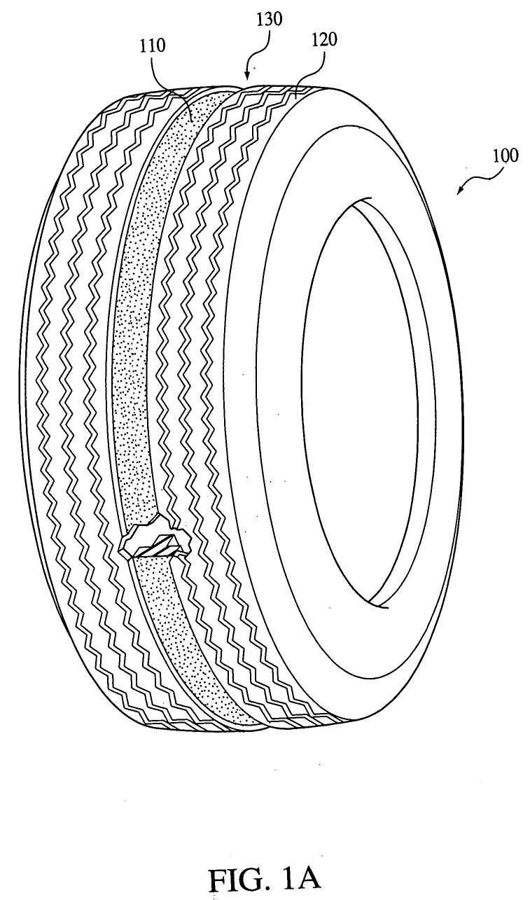

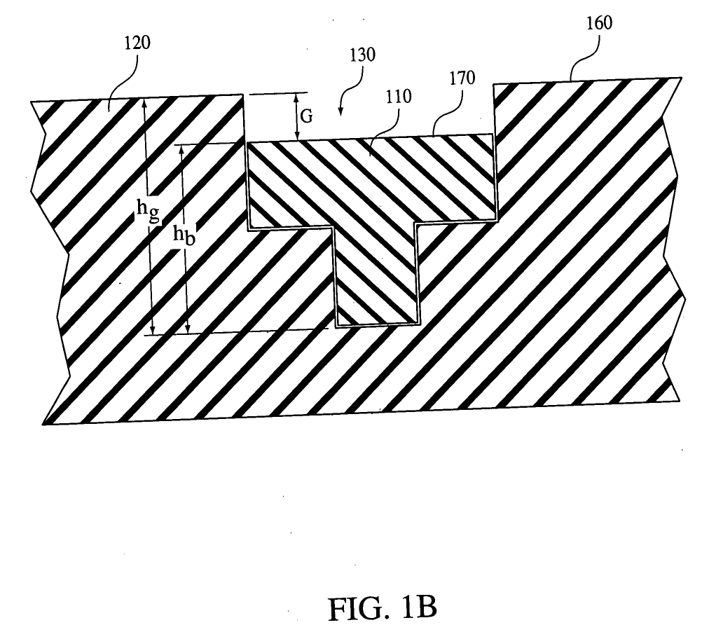

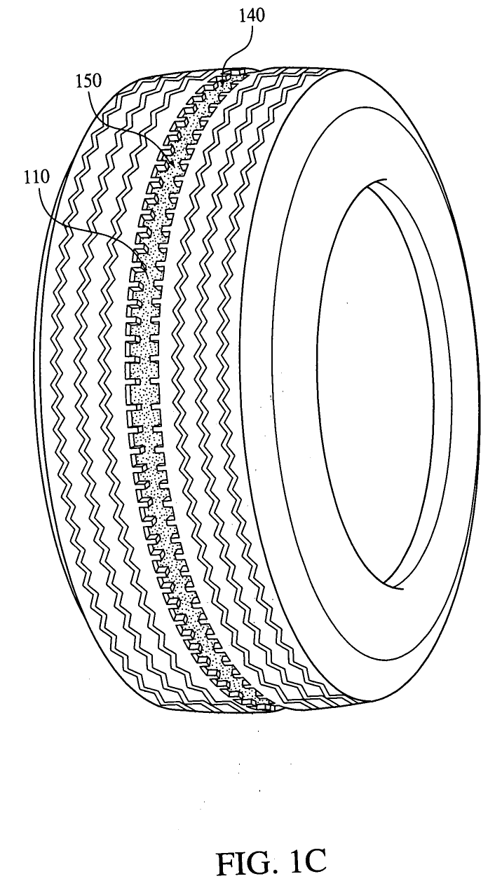

Illustrated in FIGS. 1A and 1B are perspective and cross-sectional views, respectively, of one embodiment of a tire 100 having a band 110 provided thereon. The band 110 can be configured to affect the appearance and/or a performance of the tire 100. For example, the band 110 can be configured to improve the appearance of the tire 100, which will be discussed in greater detail below. In another example, the band 110 can be configured to improve one or more tire performance attributes such as traction, handling, and/or noise reduction, which also will be discussed in greater detail below.

With reference to FIG. 1A, the tire 100 includes a circumferential tread 120 having a circumferential groove 130 provided therein. The circumferential groove 130 can be, for example, an existing groove provided in the circumferential tread 120 of the tire 100. The term “existing groove” should be understood to mean a groove that is formed in the tread of the tire in a vulcanizing mold, or formed in the circumferential tread of the tire via a secondary post-molding operation.

With reference to FIG. 1B, the band 110 is configured to be disposed within the circumferential groove 130 of the circumferential tread 120. Although the figures illustrate the tire 100 having a single band disposed within the circumferential groove 130 of the circumferential tread 120, it will be appreciated that the tire 100 can include one or more additional bands (not shown) disposed in one or more additional circumferential grooves (not shown) provided in the circumferential tread 120 of the tire 100.

The band 110 may have a cross-section that takes the form of a variety of shapes. For example, the band 110 can have a cross-section that is substantially T shaped as shown in FIG. 1B. However, in alternative embodiments (not shown), the cross-section of the band 110 can take the form of other shapes such as rectangular, triangular, square, or any other shape.

With continued reference to FIG. 1B, the band 110 has a cross-section that corresponds to the cross-section of the circumferential groove 130. In other words, the cross-sections of the band 110 and the circumferential groove 130 can be complimentary such that the band 110 has a T-shaped cross-section and the circumferential groove 130 has a T-shaped cross-section as shown in FIG. 1B. However, in alternative embodiments (not shown), the cross-sections of the band 110 and the circumferential groove 130 can differ from each other.

The band 110 can have a substantially constant cross-section along its length. For example, the cross-section of the band 110 can be T-shaped along the entire length of the band 110 as shown in FIG. 1A. However, in alternative embodiments (not shown), the substantially constant cross-section of the band 110 can take the form of other shapes such as rectangular, triangular, square, or any other shape.

In an alternative embodiment, the band 110 can have a variable cross-section along its length. For example, FIG. 1C illustrates the band 110 having a variable cross-section along its length where the cross-section of the band 110 includes alternating wide and narrow portions 140, 150, respectively, along its length. Obviously, it will be appreciated that the variable cross-section of the band 110 can include other alternating cross-sectional shapes as well as non-repeating patterns.

In another embodiment (not shown), a band can include portions that extend into non-circumferential features in the circumferential tread. For example, a circumferential tread can include a plurality of slots that communicate with a circumferential groove provided in the circumferential tread. In this case, the band can be configured with extension portions that occupy one or more of the slots in the circumferential tread.

As discussed above, the band 110 can be configured to affect the appearance of the tire 100. For example, the band 110 can be a color different than the color of the tire 100 to provide contrast between the two. In another example, the band 110 can include reflective material provided thereon to improve the visibility of the tire 100 at night. Optionally, the band 110 can include a letter, numeral, symbol, logo, trademark, ornamental design, decorative pattern, texture, or any combination thereof to enhance the appearance of the tire 100.

As discussed above, the band 110 can be configured to affect the performance of the tire 100. For example, the band 110 can be configured to affect a tire performance attribute such as noise reduction, wet traction, snow traction, ice traction, dry traction, handling, or any combination thereof.

With reference back to FIG. 1B, to affect wet and dry traction of the tire 100, the band 110 can be dimensioned to provide a gap G between an outer surface 160 of the circumferential tread 120 and an outer surface 170 of the band 110. For example, the height h_{b} of the band 110 can be less than the height h_{g} of the circumferential groove 130 resulting in the gap G. Wet and dry traction of the tire 100 can be affected depending on the size of the gap G. Generally, the larger the gap G, the greater the wet traction of the tire 100, and the smaller the gap G, the greater the dry traction of the tire 100. In this manner, the height of the band 110 can be dimensioned accordingly to achieve the desired traction. For example, the height h_{b} of the band 110 can be dimensioned to provide a negligible gap G between the outer surface 170 of the band 110 and the outer surface 160 of the circumferential tread 120 of the tire 100. In this example, the tire 100 should exhibit better dry traction and handling than wet traction and handling.

In one embodiment, the band 110 can take the form of an endless band, which can be formed in a mold or other forming apparatus. Alternatively, the band 110 can be extruded in the form of a strip, which can be cut to length. The two ends of the band 110 can then be joined together before or after installation onto the tire 100.

The band 110 can be constructed from a variety of materials. For example, to assist in the installation of the band 110 onto the tire (which will be discussed in more detail below), especially when the band 110 is a formed as an endless band, the band 110 can be constructed from an elastomeric material such as a rubber material. The rubber material can include, for example, natural rubbers, synthetic rubbers, and combinations thereof. Suitable non-limiting examples of synthetic rubbers can include styrene/butadiene (SB) copolymers, styrene butadrene styrene (SBS) copolymers, styrene butadiene rubber (SBR), polyisoprenes, polychloroprenes, polybutadienes, ethylene-propylene copolymers, acrylonitrile/butadiene copolymers, ethylene/vinyl acetate copolymers, and combinations thereof. The band 110 can also be constructed of other materials such as polymeric materials or fibrous materials.

Installation of the band 110 into the circumferential groove 130 of the circumferential tread 120 can occur after the tire 100 has been molded in a vulcanization mold. In one embodiment, the band 110 is configured to be installed in the circumferential groove 130 of the circumferential tread 120 by the tire manufacturer, tire dealer, or consumer. For example, the tire manufacturer, tire dealer, or consumer can partially or fully deflated the tire 100 before installing the band 110 into the groove 130.

The band 110 can also be configured to be replaced by the tire manufacturer, tire dealer, or consumer if the band 110 is worn or if a change in the appearance and/or performance attributes of the band 110 are desired. In this regard, the band 110 can be removed from the tire 100 and a replacement band having the same or different appearance and/or performance attributes can be installed in the circumferential groove of the tire.

In an alternative embodiment, the band 110 can be constructed of a foamed rubber composition to improve the snow and ice traction of the tire. Examples of suitable foamed rubber compositions are described in U.S. Pat. Nos. 6,497,261, 6,427,738, 6,075,098, 6,021,831, 5,968,427, 5,798,009, 5,788,786, 5,776,991, 5,571,350, 5,351,734, 5,147,477, which are all owned by Bridgestone Corporation and are hereby incorporated by reference in their entireties herein.

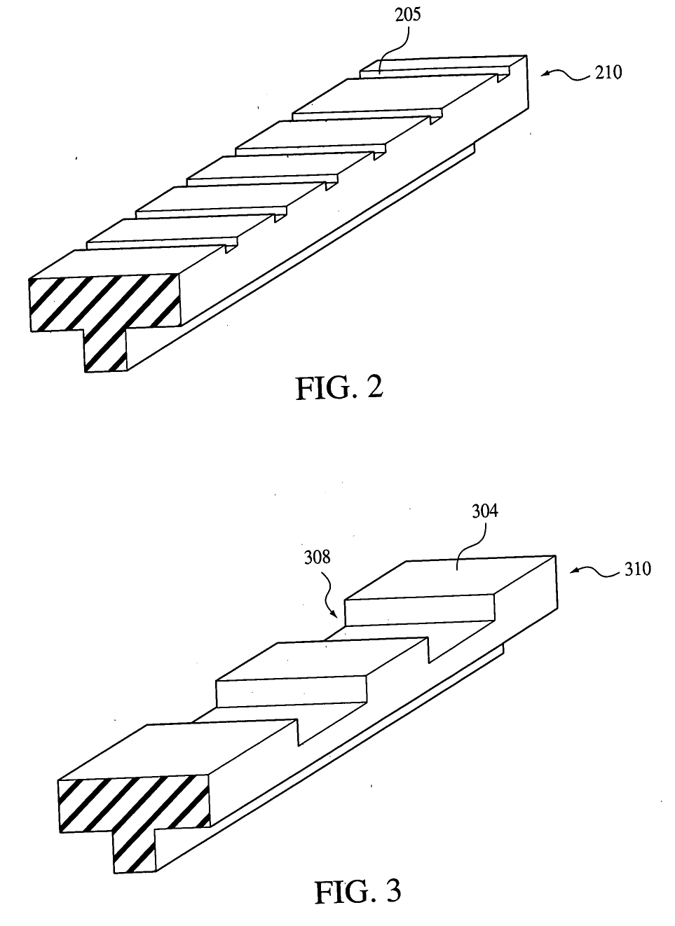

Illustrated in FIG. 2 is a perspective view of another embodiment of a band 210 for use on a tire to affect the performance of the tire. In this embodiment, lateral sipes 205 are provided on the band 210 to improve snow and ice traction of the tire. In alternative embodiments (not shown), the sipes can also be angular, wavy, or any other shape.

Illustrated in FIG. 3 is a perspective view of yet another embodiment of a band 310 for use on a tire to affect the performance of the tire. In this embodiment, a plurality of alternating lateral lugs 304 and slots 308 are provided on the band 310 to improve snow and ice traction of the tire. Alternatively, a plurality of alternating angled lugs and slots can be provided on the band to create a different pattern.

In one embodiment, a methodology is provided for affecting the appearance and/or performance of a tire. The methodology includes installing a band having at least one tire appearance and/or performance affecting attribute into a circumferential groove that is provided in a circumferential tread of a tire. The band can be, for example, installed into the circumferential groove using an installation device. Alternatively, the band can be installed into the circumferential groove by stretching the band over the tread of the tire and seating the band into the circumferential groove.

Optionally, a band can be replaced with a replacement band as described above that has the same or different tire appearance and/or performance attributes. The band can be replaced by removing the original band from the tire and installing the replacement band into the circumferential groove in the manner as discussed above.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application illustrates various embodiments, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A tire comprising:
a circumferential tread configured with at least one circumferential groove; and
a band disposed in the at least one circumferential groove.

2. The tire of claim 1 wherein the groove has a variable cross-section.

3. The tire of claim 1 wherein the groove has a cross-section and the band has a cross-section that corresponds to the cross-section of the groove.

4. The tire of claim 1 wherein the tread includes a plurality of slots that communicate with the groove in the tread, the band configured to be disposed in one or more of the slots in the tread.

5. The tire of claim 1 wherein a gap is defined between an outer surface of the tread and an outer surface of the band.

6. The tire of claim 1 wherein the band is configured to be replaceable.

7. The tire of claim 1 wherein the band is constructed of an elastomeric material.

8. The tire of claim 1 wherein the band is constructed of a polymeric material.

9. The tire of claim 1 wherein the band is a different color than the tire.

10. The tire of claim 1 wherein the band affects one or more tire performance attributes that includes one or more of, noise reduction, wet traction, snow traction, ice traction, dry traction, and handling.

11. The tire of claim 1 further comprising another band disposed in another circumferential groove in the tread.

12. An article for use on a tire having a circumferential tread with at least one circumferential groove, the article comprising:
a band configured to be installed within the at least one groove of the tread, the band being configured to affect the appearance and/or performance of the tire.

13. The article of claim 12 wherein the groove has a variable cross-section and the band has a variable cross-section that is complimentary to the variable cross-section of the at least one groove.

14. The article of claim 12 wherein the at least one groove has a cross-section and the band has a cross-section that corresponds to the cross-section of the at least one groove.

15. The article of claim 12 wherein the band is constructed of an elastomeric material.

16. The article of claim 12 wherein the band is constructed of a fibrous material.

17. The article of claim 12 wherein the band is constructed of a foamed rubber composition to improve ice and snow traction.

18. The article of claim 12 wherein the band is a different color than the tire.

19. The article of claim 12 wherein the band includes a reflective material.

20. The article of claim 12 wherein the band is provided with designs, markings, textures or lettering.

21. The article of claim 12 wherein the band is provided with lateral sipes.

22. The article of claim 12 wherein the band is provided with a lateral lug and slot configuration.

23. The article of claim 12 wherein the band is an endless band.

24. The article of claim 12 wherein the band includes first and second ends joined together before or after installation into the at least one groove.

25. A method of affecting the appearance and/or performance of a tire having a tread with one or more circumferential grooves, the method comprising:
installing a band having at least one tire appearance and/or performance affecting attribute into one of the grooves in the tread.

26. The method of claim 25 further comprising:
replacing the band with another band having the same or different tire appearance and/or performance affecting attributes.
